(19) United States
(12) Patent Application Publication
(10) Pub. No.: US 2017/0202726 A1
(43) Pub. Date: Jul. 20, 2017

(54) WALKING ASSISTANCE ROBOT LOAD COMPENSATION SYSTEM AND WALKING TRAINING APPARATUS HAVING SAME

(71) Applicant: P & S MECHANICS CO., LTD., Seoul (KR)

(72) Inventors: Kwang Hun PARK, Seoul (KR); Dong Chan LEE, Seongnam-Si, Gyeonggi-Do (KR); Ki Hong LEE, Bucheon-Si, Gyeonggi-Do (KR); Jong Hyeok KIM, Gwangmyeong-Si, Gyeonggi-Do (KR)

(21) Appl. No.: 15/324,678

(22) PCT Filed: Sep. 25, 2014
(86) PCT No.: PCT/KR2014/008938

§ 371 Date: Jan. 6, 2017

(30) Foreign Application Priority Data
Jul. 7, 2014 (KR) 10-2014-0084588

(51) Int. Cl. A61H 3/00

(52) U.S. Cl. CPC A61H 3/00; A61H 2205/10

(57) ABSTRACT

The present invention relates to a walking assistance robot load compensation system which cancels out the load of a walking assistance robot worn by a walking trainee, the walking assistance robot load compensation system comprising a dynamic compensation part compensating for a dynamic load which changes according to the displacement or inertia of the walking assistance robot, the dynamic compensation part, which may compensate for a dynamic load which changes according to the displacement or inertia of the walking assistance robot, comprising: a first plate which is movable in association with the displacement or inertia; a second plate which is spaced apart from the first plate and is movable; a connection wire which is connected to the first and second plates; and a dynamic compensation unit which applies resistance force to the connection wire.

### CROSS-REFERENCE TO RELATED APPLICATION

This application claims priority to and the benefit of Korean Patent Application No. 10-2014-0084588 filed in the Korean Intellectual Property Office on Jul. 7, 2014, the entire contents of which are incorporated herein by reference.

### TECHNICAL FIELD

The present invention disclosed herein relates to a walking assistance robot load compensation system and a walking training apparatus having the same, and more specifically, to a walking assistance robot load compensation system and a walking training apparatus having the same which can compensate for a dynamic load changing according to the displacement or inertia of a walking assistance robot.

### BACKGROUND ART

In general, a walking training apparatus is an apparatus for rehabilitation of patients having numbness symptoms on the lower half of the body or patients having difficulties in normal walking by abnormality on joints and muscular strength on the limb.

Most of patients having trouble in walking have difficulty in moving their own legs by themselves. Therefore, the patients perform walking training with bending or moving the legs according to a walking pattern led by a walking training apparatus with a state where they wear it. Such a walking assistance robot has its own native load. Therefore, conventionally, the load of the walking assistance robot has been canceled out via a tractor of the walking assistance robot for patients to feel no load of the walking assistance robot.

However, the conventional tractor of the walking assistance robot has canceled out the load of walking assistance robot applied to the patients based on the patients in a static state. Accordingly, since a dynamic load of the walking assistance robot is changed by the displacement or inertia of the walking assistance robot when the walking assistance robot moves, the tractor of the walking assistance robot was not able to cancel out the changing dynamic load. Therefore, the patients wearing the walking assistance robot do not sense the load of the walking assistance robot in its static state, but do sense the changing dynamic load of the walking assistance robot in its dynamic state where the walking assistance robot is moving, which leads discomfort to the patents and excessiveness to the limb, resulting in a walking training lacking in safety.

### RELATED ART DOCUMENT

Korean registered patent gazette No. 10-1074754

### DISCLOSURE

### Technical Problem

The present invention is to provide a walking assistance robot load compensation system and a walking training apparatus having the same which can minimize the change of a dynamic load according to a displacement or inertia of a walking assistance robot.

And the present invention is to provide a walking assistance robot load compensation system and a walking training apparatus having the same which can perform walking training safely for a walking trainee to feel no discomfort.

### Technical Solution

The present invention is a walking assistance robot load compensation system to cancel out a load of a walking assistance robot worn by a walking trainee, comprising a dynamic compensation part compensating for a dynamic load changing according to the displacement or inertia of the walking assistance robot, the dynamic compensation part comprising a first plate movable in association with the displacement or inertia, a second plate that is spaced apart from the first plate and is movable, a connection wire connected to the first and the second plates, and a dynamic compensation unit applying resistance force to the connection wire.

The dynamic compensation unit comprises a pulley rotated by the connection wire, a cam rotating in connection with the pulley, and an elastic body providing frictional force to the cam that is rotating.

A rotation axis of the cam is deployed eccentrically from a gravity center portion of the cam.

The dynamic compensation unit further comprises a case receiving the cam and the elastic body, a cover sealing up inside of the case, and a lever adjusting position of the cam, wherein lubricant is provided inside of the cam.

The elastic body is deployed in two directions crossing at right angles to the rotation axis of the cam.

The walking assistance robot load compensation system further comprises a guide part comprising a guide body, a moving block connected to the first plate, the second plate or the walking assistance robot and movably connected to the guide body, a guide shaft installed on the guide body, and a fixing member connected to the guide shaft to fix a position where the dynamic compensation unit is deployed.

The guide part further comprises a position adjuster adjusting a position of the fixing member where the dynamic compensation unit is fixed.

The walking assistance robot load compensation system further comprises a static compensation part comprising a wire connected to the walking assistance robot, and an elasticity unit connected to the wire to maintain tensile force constantly.

The elasticity unit comprises a spring balancer.

And the present invention is a walking training apparatus, comprising a counter load system applying a counter load to a walking trainee, a walking assistance robot worn on the limb of the walking trainee, and a walking assistance robot load compensation system of any one of claims 1 to 9 supporting the walking assistance robot and compensating for a dynamic load changing according to the displacement or inertia of the walking assistance robot.

The walking training apparatus further comprises a frame supporting the walking assistance robot, and a connection member deployed between the walking assistance robot load compensation system and the frame to connect the walking assistance robot load compensation system and the frame.

One end of the connection member is hinge-coupled to the frame, and the connection member pivots to move the walking assistance robot to a wearing position of the walking trainee.

The walking training apparatus further comprises a treadmill providing a moving floor face to the walking trainee.

The walking training apparatus further comprises a controller controlling driving of at least one of the counter load system, the walking assistance robot, the treadmill and the walking assistance robot load compensation system to change walking condition of the walking trainee.

### Advantageous Effects

A walking training apparatus according to an embodiment of the present invention comprises a dynamic compensation part compensating for a dynamic load changing according to a displacement or inertia of a walking assistance robot, thereby minimizing that the dynamic load of the walking assistance robot is changed according to the displacement or inertia of the walking assistance robot while the walking assistance robot is moving during walking training. Therefore, the sense of discomfort or fatigue that patients performing a walking training feel owing to the load of the walking assistance robot is reduced to improve the efficiency of a walking training.

And the walking assistance robot can be supported with stability and the excessiveness to the walking trainee can be reduced, thereby the walking trainee being able to perform walking training with safety. And the dynamic compensation part is formed in a simple structure to be able to compensate for a changing dynamic load of the walking assistance robot, thereby the apparatus being able to be simplified and space efficiency be improved.

And the connection member connected to the walking assistance robot pivots to move the walking assistance robot to a wearing position of the walking trainee, thereby the walking trainee being able to attach and detach the walking assistance robot with ease.

### DESCRIPTION OF DRAWINGS

FIG. 1 is a drawing showing a walking assistance robot load compensation system according to an embodiment of the present invention.

FIG. 2 is a drawing showing an operation of a dynamic compensation part according to an embodiment of the present invention.

FIG. 3 is an exploded perspective view showing a dynamic compensation unit according to an embodiment of the present invention.

FIG. 4 is a drawing showing an operation of a connection member according to an embodiment of the present invention.

### BEST MODE

Hereinafter, some embodiments of the present invention will be described in detail with reference to drawings attached. However, the present invention is not limited to the embodiments disclosed below, but may be implemented in various details different to each other, and the embodiments are provided only for completing disclosure of the present invention and facilitating for ordinary skilled persons to understand the scope of the invention. For the purpose of detailed description, the drawings may be exaggerated with the same marks on the drawings designating the same elements.

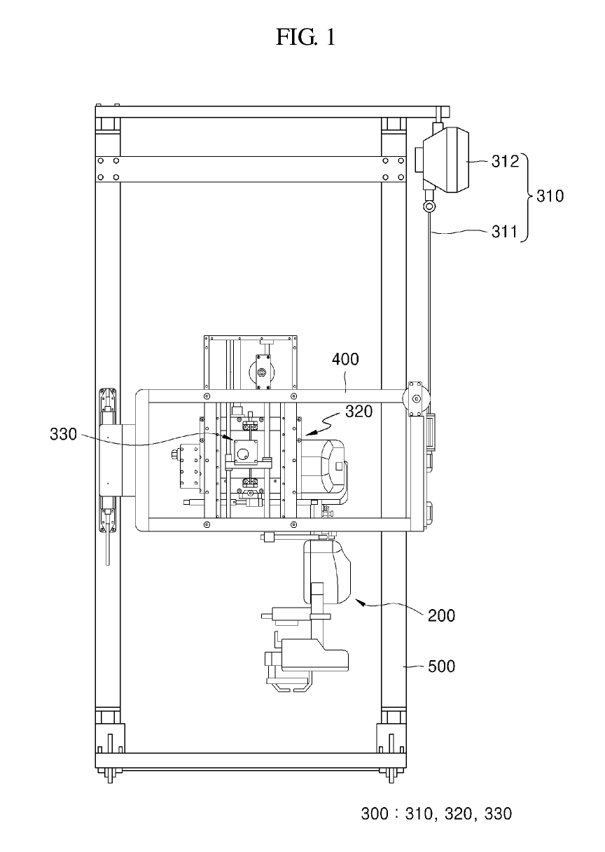

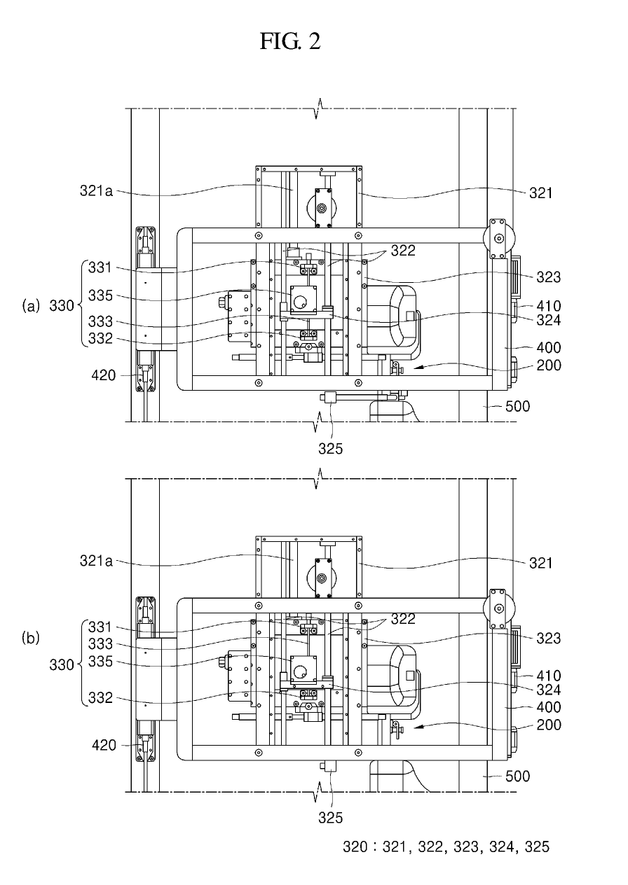

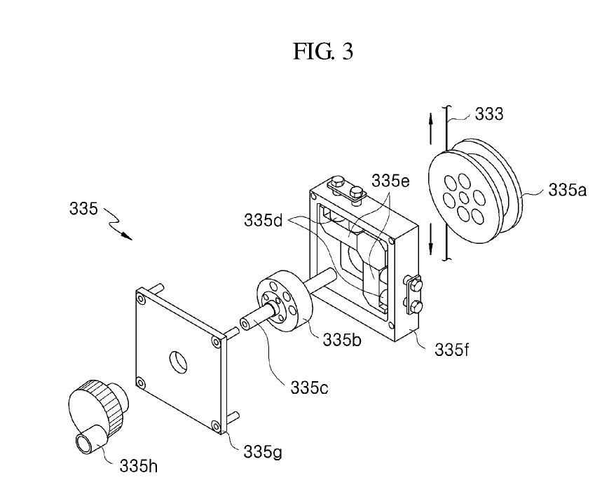

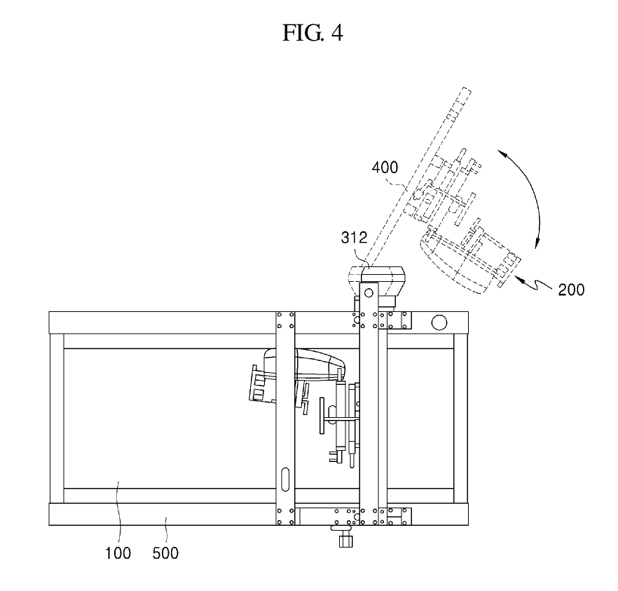

FIG. 1 is a drawing showing a walking assistance robot load compensation system according to an embodiment of the present invention, FIG. 2 is a drawing showing an operation of a dynamic compensation part according to an embodiment of the present invention, FIG. 3 is an exploded perspective view showing a dynamic compensation unit according to an embodiment of the present invention, and FIG. 4 is a drawing showing an operation of a connection member according to an embodiment of the present invention.

Referring to FIG. 1 or FIG. 2, a walking assistance robot load compensation system 300 according to an embodiment of the present invention is a walking assistance robot load compensation system canceling out a load of a walking assistance robot 200 worn by a walking trainee. The walking assistance robot load compensation system 300 comprises a dynamic compensation part 330 compensating for a dynamic load changing according to the displacement or inertia of the walking assistance robot 200, and may further comprise a guide part 320 and a static compensation part 310.

The walking trainees are patients having trouble in walking most of whom have difficulty in walking for themselves. Therefore, the walking assistance robot load compensation system 300 supports the walking assistance robot 200 to cancel out the load of the walking assistance robot 200. Accordingly, in case that the walking trainee wears the walking assistance robot 200 and performs walking training, the walking trainee can perform walking training hardly feeling the load of the walking assistance robot 200.

However, when the walking trainee performs walking training, the walking assistance robot 200 moves and the displacement occurs, thereby the position of gravity center of the walking assistance robot 200 keeping changing. Accordingly, the load of the walking assistance robot 200 cannot be canceled out constantly, thereby the walking trainee sensing a portion of the load of the walking assistance robot 200. And when making the walking assistance robot 200 into operation, it is difficult to make the walking assistance robot 200 move since the walking assistance robot 200 has an inertia which persists to stay at first, and when the walking assistance robot 200 moves, it is easy to make it move since it has an inertia which persists to keep moving.

Accordingly, since the force by which the walking assistance robot 200 moves is different according to the inertia, when a same force is applied for operation to the walking assistance robot 200 from beginning to end, the walking trainee may sense the change of the dynamic load by the difference. Therefore, the walking assistance robot load compensation system 300 according to an embodiment of the present invention has the dynamic compensation part 330. That is, using the dynamic compensation part 330, the changing dynamic load of the walking assistance robot 200 according to the displacement or inertia is compensated, thereby the change of the dynamic load being suppressed.

First, for understanding of the present invention, a description for the static compensation part 310 and the guide part 320 will be given. The static compensation part 310 comprises a wire 311 connected to the walking assistance robot 200, and an elasticity unit 312 connected to the wire 311 to maintain tensile force constantly.

One end of the wire 311 may be connected to the walking assistance robot 200 and the other end to the elasticity unit 312 which will be described later. Accordingly, via the wire 311, the elasticity unit 312 may provide a static compensation for the walking assistance robot 200.

The elasticity unit 312 takes a role to apply constant tensile force to the walking assistance robot 200. For example, the elasticity unit 312 may be a spring balancer. Accordingly, the elasticity unit 312 may pull walking assistance robot 200 with a same power even though the walking assistance robot 200 may move to any position such as 100 mm, 500 mm, and 800 mm from the surface. Therefore, when the walking assistance robot 200 moves upwards, the elasticity unit 312 provides static compensation by applying constant tensile force, thereby walking assistance robot 200 being able to be moved vertically with little force. However it is not limited to the spring balancer, but a variety of members capable of applying elasticity or tensile force may be used.

The elasticity unit 312 as such applies tensile force based on the load of the walking assistance robot 200 before performing walking training at a static state, or at a stop state. Therefore, when walking assistance robot 200 moves for walking training, owing to the displacement or inertia persisting to keep moving, the walking trainee may sense the load of the walking assistance robot 200 which has been canceled out at a stop state. The dynamic load of the walking assistance robot 200 sensed by the walking trainee may cause feeling of discomfort to the walking trainee, and may give excessiveness to the walking trainee to cause performing walking training lacking safety. Accordingly, the dynamic compensation part 330 is provided to compensate for the dynamic load of the walking assistance robot 200 changing according to the displacement or inertia of the walking assistance robot 200, thereby the change of the dynamic load is suppressed.

The guide part 320 comprises a guide body 321, a moving block 323 which is connected to a first plate 331 or a second plate 332 which will be described later or the walking assistance robot 200 and is movably connected to the guide body 321, a guide shaft 322 installed on the guide body 321, and a fixing member 324 which is connected to the guide shaft 322 and fixes a position for a dynamic compensation unit 335 to be deployed which will be described later, and may further comprise a position adjuster 325.

The guide body 321 may be formed in a shape of plate and may be fixed at a deployed position.

The moving block 323 may be formed in a shape of plate, one end of which may be connected to the walking assistance robot 200 and the other end of which may be movably connected to the guide body 321. For example, an LM guide 321a formed to extend in vertical direction is provided to be connected to the guide body 321. The moving block 323 is connected to the LM guide 321a provided to the guide body 321 and may move vertically along the extending direction of the LM guide 321a. Accordingly, when the walking assistance robot 200 moves and the displacement occurs, the moving block 323 connected to the walking assistance robot 200 may move vertically according to the displacement of the walking assistance robot 200. However, the structure of the guide body 321 and the moving block 323 is not limited as such, but may be various, and the method in which the moving block 323 is movably connected to the guide body 321 is not limited as such, but may be various.

The guide shaft 322 may be formed to extend in vertical direction to be deployed in a parallel direction to the LM guide 321a. And the guide shaft 322 may be provided in plurality. For example, the guide shaft 322 may be provided in a pair. Accordingly, the fixing member 324 which will be described later can be supported with more stability than in the case of being supported by one guide shaft 322.

The fixing member 324 may be formed in a shape of plate, both sides of which may be connected to a pair of guide shafts 322. At upper side of the fixing member 324, the dynamic compensation unit 335 which will be described later may be deployed and the fixing member 324 can support the dynamic compensation unit 335. Accordingly, the fixing member 324 can fix the position where the dynamic compensation unit 335 is deployed. Therefore, as shown in FIG. 2, even though the moving block 323, the first plate 331 and the second plate 332 connected to the moving block 323 which will be described later move vertically owing to the displacement or inertia of the walking assistance robot 200, the dynamic compensation unit 335 is fixed to be able to apply resistance force to a connection wire 333 moving vertically in connection with the first plate 331 and the second plate 332. However, the shape of the fixing member 324 is not limited as such, but may be various.

The position adjuster 325 can adjust the position on the fixing member 324 where the dynamic compensation unit 335 which will be described later is fixed. For example, an electromagnetic brake or a manual lever can be used as the position adjuster 325. That is, the fixing member 324 is vertically movable along the extending direction of the guide shaft 322 and is fixed to the position deployed by the position adjuster 325 to be able to fix the dynamic compensation unit 335. Accordingly, even though the connection wire 333 which will be described later moves to any position by the displacement or inertia of the walking assistance robot 200, after moving and fixing the fixing member 324, the dynamic compensation unit 335 can apply resistance force to the connection wire 333.

The dynamic compensation part 330 comprises the first plate 331 movable in association with the displacement or inertia of the walking assistance robot 200, the second plate 332 which is spaced apart from the first plate 331 and is movable, the connection wire 333 connected to the first plate 331 and the second plate 332, and the dynamic compensation unit 335 applying resistance force to the connection wire 333.

The first plate 331 may be formed in a shape of plate and may be formed in a variety of shapes such as circular plate, rectangular plate, and so on. The first plate 331 may be connected to the moving block 323 or the walking assistance robot 200. Accordingly, when the walking assistance robot 200 moves, it may move vertically along the walking assistance robot 200 or along the moving block 323 moved by the walking assistance robot 200.

The second plate 332 may be formed in a shape of plate and may be formed in a variety of shapes such as circular plate, rectangular plate, and so on. The second plate 332 is spaced apart from the lower side of the first plate 331. And the second plate 332 may be connected to the moving block 323 or the walking assistance robot 200. Accordingly, when the walking assistance robot 200 moves, it may move vertically along the walking assistance robot 200 or along the moving block 323 moved by the walking assistance robot 200.

One end of the connection wire 333 is connected to the first plate 331 and the other end to the second plate 332. Accordingly, when the first plate 331 or the second plate 332 moves along the walking assistance robot 200 or the moving block 323, the connection wire 333 may move vertically together.

Referring to FIG. 3, the dynamic compensation unit 335 comprises a pulley 335a rotated by the connection wire 333, cam 335b and 335c rotating in connection with the pulley 335a, and elastic body 335d providing frictional force to the cam 335b and 335c that is rotating, and may further comprise a case 335f, a cover 335g, and a lever 335h.

The pulley 335a may be formed in a shape of circular plate, and may be rotatable on a center axis. Groove is formed on the circumference of the pulley 335a, and the connection wire 333 may contact into the groove of the pulley 335a. Accordingly, while the connection wire 333 moves vertically along the first plate 331, the connection wire 333 may rotate the pulley 335a which is contacting. However, the shape of the pulley 335a is not limited as such, but may be various.

The cam 335b and 335c may comprise a rotation axis 335c connected to the pulley 335a to rotate, and a cam part 335b provided on the rotation axis 335c. The cam part 335b may be formed in a shape of circular plate, and the rotation axis 335c may be connected to the cam part 335b eccentrically from a gravity center portion of the cam part 335b. Accordingly, rotation radius of one side and the other side of the cam part 335b by the rotation axis 335c may be varied. Therefore, a portion having larger rotation radius of the cam part 335b rotates with compressing the elastic body 335d which will be described later with more pushing the elastic body 335d or a contact member 335e connected to the elastic body 335d, thereby larger frictional force from the elastic body 335d being able to be provided. And a portion having smaller rotation radius of the cam part 335b do not contact or less contact to the elastic body 335d or the contact member 335e connected to the elastic body 335d, thereby no frictional force or only less frictional force from the elastic body 335d being able to be provided.

On the other hand, the cam part may be formed to protrude in a part. Accordingly, the rotation radius of the protruded part and that of unprotruded part of the cam part by the rotation axis 335c may be different. Therefore, the protruded part of the cam part contacts more to the elastic body 335d which will be described later or the contact member 335e connected to the elastic body 335d to rotate with pushing the elastic body 335d, by which a larger frictional force from the elastic body 335d may be provided. And the unprotruded part of the cam part do not contact or less contact to the elastic body 335d, by which no frictional force or only less frictional force from the elastic body 335d can be provided. However, the shape of the cam part is not limited as such, but may be various.

The elastic body 335d may be a spring having elastic force. And the elastic body 335d may be deployed one or more in directions crossing at right angles to the rotation axis 335c of the cam. Accordingly, it may interrupt the rotation of the cam part 335b with either direct or indirect contact to a part having larger rotation radius or to a protruded part of the cam part 335b. Then, the rotation of the pulley 335a connected to the cam 335b and 335c is interrupted, and resistance force may be applied to the connection wire 333 moving with contact to the pulley 335a.

For example, the elastic body may be deployed in two directions crossing at right angles to the rotation axis 335c of the cam to be deployed at upper side and side part of the cam part 335b. Therefore, the part having larger rotation radius or the protruded part of the cam part 335b is provided with frictional force at a section where the elastic body 335d is deployed and is provided with no frictional force at a section where the elastic body 335d is not deployed, thereby a time point to provide frictional force of the cam part 335b being able to be selected. That is, the cam part 335b applies force upwards with rotating to compress the elastic body 335d at upper side. Then the compressed elastic body 335d provides force to the opposite direction against the force delivered by the cam part 335b, that is downwards with attempting to increase by elastic force. Accordingly, the force of the elastic body 335d is delivered to the cam part 335b in another direction to the rotating direction of the cam part 335b to interrupt the rotation of the cam part 335b. The elastic body 335d provided at a side part of the cam part 335b also may be compressed by the rotating cam part 335b and be stretched, to deliver force to the cam part 335b in another direction to the rotating direction of the cam part 335b, thereby interrupting the rotation of the cam part 335b.

Here, the lever 335h adjusting position of the cam 335b and 335 may be provided. The lever 335h is connected to the cam 335b and 335c and rotates the cam part 335b, thereby a time point for the cam part 335b to be provided with elastic force from the elastic body 335d being able to be set up. Accordingly, a starting point to make the dynamic compensation may be set up according to situation of the walking trainee.

And miniaturization is possible than when the elastic body 335d is deployed in four or three directions, thereby the installation and maintenance becoming easy. However, it is not limited to such, but various members having elastic force such as urethane and so on may be used.

Here, the elastic body 335d is further provided with the contact member 335e. The contact member 335e is formed in a shape of plate to be able to contact to the rotating cam part 335b. Therefore, the elastic body 335d contacts to the cam part 335b indirectly via the contact member 335e, thereby the elastic body 335d being prevented from being worn out or damaged by the rotating cam part 335b.

The case 335f forms an inside space receiving the cam part 335b and the elastic body 335d, a part of which may be opened. Accordingly, the elastic body 335d may be installed on the inner wall of the case 335f and the cam part 335b may be rotated in the case 335f. And cover 335g may be provided at an opened part of the case 335f to be able to seal up inside of the case 335f. Therefore, in case that the cam part 335b, the elastic body 335d or the contact member 335e is damaged, the cover 335g is opened to facilitate easy repair. And lubricant is provided inside of the case 335f which is sealed up, to facilitate easy rotation of the cam 335b and 335c inside of the case 335f.

Accordingly, the dynamic compensation unit 335 may interrupt the movement of the connection wire 333 connected to the first plate 331 which is attempting to move vertically by the walking assistance robot 200 or the moving block 323 contacting to the connection wire 333. That is, in the dynamic compensation unit 335, the elastic body 335d applies frictional force to cam 335b and 335c in another direction to the rotating direction of the cam 335b and 335c, thereby interrupting the rotation of the cam 335b and 335c. Therefore, by frictional force applied by the elastic body 335d, the rotation of the pulley 335a connected to the cam 335b and 335c is also interrupted, thereby resistance between the connection wire 333 attempting to rotate the pulley 335a and the pulley 335a occurring. Then, the movement of the first plate 331 and the second plate 332 attempting to move vertically by the displacement or inertia of the walking assistance robot 200 is interrupted to be able to suppress or minimize the change of the dynamic load of the walking assistance robot 200. Therefore, the sense of discomfort or fatigue that the walking trainee performing walking training feels owing to the load of the walking assistance robot 200 is reduced to be able to improve the efficiency of walking training. And the dynamic compensation part 330 has a simple structure to be able to compensate for the dynamic load changing according to the displacement or inertia, thereby the apparatus being simplified and the space efficiency being improved.

In the following, a walking training apparatus according to an embodiment of the present invention will be described.

Referring to FIG. 4, the walking training apparatus according to an embodiment of the present invention comprises a counter load system not shown applying a counter load to the walking trainee, a walking assistance robot 200 worn on the limb of the walking trainee, and a walking assistance robot load compensation system 300 of any one of claims 1 to 7 supporting the walking assistance robot 200 and compensating for the dynamic load changing according to the displacement or inertia of the walking assistance robot 200, and may further comprise a treadmill not shown, a controller not shown, a frame 500, and a connection member 400.

The treadmill provides a moving floor face to the walking trainee at a home position. Such a treadmill may be operated at a walking speed within 0.3˜3.0 km/h range synchronized to that of walking assistance robot 200 during operation of the walking training apparatus, which may be controlled automatically by the controller according to the state of the walking trainee and the object of training. And it may be operated manually along the will of the walking trainee. The treadmill is movable with wheels installed on the bottom and the position of the apparatus may be fixed via brakes after moving.

The counter load system comprises a driver, a main wire, a harness, and a connection bar, thereby applying the counter load to the walking trainee wearing the harness. That is, when the driver pulls the main wire, the connection bar connected to the main wire moves upwards and the harness connected to the connection bar also moves upwards, thereby the walking trainee being towed upwards. Accordingly, the load of the walking trainee may be reduced. Alternatively, a counter load weight may be used instead the driver to cancel out the load of the walking trainee by the load of the counter load weight. However, it is not limited as such, but the counter load may be applied to the walking trainee in various ways.

The walking assistance robot 200 may be formed in a shape being able to be worn on the limb of the walking trainee. For example, walking assistance robot 200 may include a hip joint robot worn on a hip joint, a knee joint robot worn on a knee joint, and an ankle joint robot worn on an ankle joint, among lower body joint, of which only one joint robot may be selected and used according to the patient. The walking assistance robot 200 is installed on the limb of the walking trainee and driven to perform a function of assistance on walking of walking trainee who has trouble in walking. And among the robots of the walking assistance robot 200, a length adjuster not shown may be provided which may adjust according to the length of the legs of the walking trainee. The length adjuster can adjust automatically for matching to body type of the walking trainee and in case that there occurs an error after automatic length adjustment, a manual fine adjustment of segment length may be possible.

The walking assistance robot load compensation system 300 is a walking assistance robot load compensation system canceling out the load of the walking assistance robot 200 worn by the walking trainee, and comprises the dynamic compensation part 330 compensating for the dynamic load changing according to the displacement or inertia of the walking assistance robot 200, and may further comprise the guide part 320 and the static compensation part 310. Accordingly, it may be suppressed or minimized that the dynamic load of the walking assistance robot 200 is changed by the displacement or inertia of the walking assistance robot 200. Therefore, the sense of discomfort or fatigue that the walking trainee performing walking training feels owing to the load of the walking assistance robot 200 is reduced to be able to improve the efficiency of the walking training. And the dynamic compensation part 330 has a simple structure and can compensate for the dynamic load changing according to the displacement or inertia, thereby the apparatus being simplified and the space efficiency being improved.

The controller may control the driving of at least any one of the counter load system, the walking assistance robot 200, the treadmill and the walking assistance robot load compensation system 300 to change the walking condition of the walking trainee, and can generate or store the driving information. For example, when the speed of the treadmill and stride range is entered into the controller according to the state of the walking trainee and the training object, the treadmill may be operated within the entered range. And according to body condition of the walking trainee, by operating the walking assistance robot load compensation system 300, the walking assistance robot 200 may be moved to a height for the walking trainee to wear it.

The frame 500 may support the walking assistance robot 200, the walking assistance robot load compensation system 300, and so on.

The connection member 400 is deployed between the walking assistance robot load compensation system 300 and the frame 500 to connect the walking assistance robot load compensation system 300 and the frame 500. That is, the center part of the connection member 400 is connected to the guide body 321 and both end parts to the frame 500. And the guide body 321 may be engaged and fixed to the connection member 400. For example, the connection member 400 may be hinge-coupled to the frame 500 at one end, which may pivot to move the walking assistance robot to a wearing position of the walking trainee. That is, at one end of the connection member 400, a hinge part 410 may be provided to be connected to one side of the frame 500 and at the other end a fixing unit 420 is provided to be connected to the other side of the frame 500.

The fixing unit 420 may be a latch. Accordingly, when releasing the fixing unit 420, the connection member 400 pivot on the hinge part 410 and the walking assistance robot load compensation system 300 and the walking assistance robot 200 connected to the connection member 400 may be moved together. Therefore, the walking trainee can board on the walking training apparatus with ease. And then, when rotating the connection member 400 in opposite direction to lock the fixing unit 420 on the frame 500, the walking assistance robot 200 moves to boarding position of the walking trainee for the walking trainee to wear the walking assistance robot 200 with ease to be able to perform walking training. In reverse, in case that the walking trainee gets off from the walking training apparatus after walking training, by releasing the fixing unit 420 and rotating the connection member 400, the walking trainee may get off from the walking training apparatus with ease.

As mentioned above, though some specific embodiments are described in detailed description of the present invention, various changes may be possible within the scope of the present invention without deviation. Therefore, the scope of the present invention should not be determined in the limitation of the embodiments described, but should be determined by the claims as well as the equivalents thereof.

1. A walking assistance robot load compensation system to cancel out a load of a walking assistance robot worn by a walking trainee, comprising a dynamic compensation part that compensate for a dynamic load changing according to the displacement or inertia of the walking assistance robot, the dynamic compensation part comprising a first plate movable in association with the displacement or inertia; a second plate that is spaced apart from the first plate and is movable; a connection wire connected to the first and the second plates; and a dynamic compensation unit applying resistance force to the connection wire.

2. The walking assistance robot load compensation system according to claim 1, the dynamic compensation unit comprising a pulley rotated by the connection wire; a cam rotating in connection with the pulley; and an elastic body providing frictional force to the cam that is rotating.

3. The walking assistance robot load compensation system according to claim 2, a rotation axis of the cam being deployed eccentrically from a gravity center portion of the cam.

4. The walking assistance robot load compensation system according to claim 2, the dynamic compensation unit further comprising a case receiving the cam and the elastic body; a cover sealing up inside of the case; and a lever adjusting position of the cam, wherein lubricant is provided inside of the cam.

5. The walking assistance robot load compensation system according to claim 2, wherein the elastic body is deployed in two directions crossing at right angles to a rotation axis of the cam.

6. The walking assistance robot load compensation system according to claim 1, further comprising a guide part comprising a guide body; a moving block connected to the first plate, the second plate or the walking assistance robot and movably connected to the guide body; a guide shaft installed on the guide body; and a fixing member connected to the guide shaft to fix a position where the dynamic compensation unit is deployed.

7. The walking assistance robot load compensation system according to claim 6, the guide part further comprising a position adjuster adjusting a position of the fixing member where the dynamic compensation unit is fixed.

8. The walking assistance robot load compensation system according to claim 1, further comprising a static compensation part comprising a wire connected to the walking assistance robot; and an elasticity unit connected to the wire to maintain tensile force constantly.

9. The walking assistance robot load compensation system according to claim 8, the elasticity unit comprising a spring balancer.

10. A walking training apparatus, comprising a counter load system applying a counter load to a walking trainee; a walking assistance robot worn on the limb of the walking trainee; and a walking assistance robot load compensation system of claim 1 supporting the walking assistance robot and compensating for a dynamic load changing according to the displacement or inertia of the walking assistance robot.

11. The walking training apparatus according to claim 10, further comprising a frame supporting the walking assistance robot; and a connection member deployed between the walking assistance robot load compensation system and the frame to connect the walking assistance robot load compensation system and the frame.

12. The walking training apparatus according to claim 11, wherein one end of the connection member is hinge-coupled to the frame, and the connection member pivots to move the walking assistance robot to a wearing position of the walking trainee.

13. The walking training apparatus according to claim 10, further comprising a treadmill providing a moving floor face to the walking trainee.

14. The walking training apparatus according to claim 13, further comprising a controller controlling driving of at least one of the counter load system, the walking assistance robot, the treadmill and the walking assistance robot load compensation system to change walking condition of the walking trainee.
